(19) United States
(12) Patent Application Publication
(10) Pub. No.: US 2025/0050387 A1
(43) Pub. Date: Feb. 13, 2025

(54) PROTECTION ASSEMBLY FOR AN ULTRASOUND CLEANING DEVICE FOR CLEANING AN OPTICAL SURFACE, COMPRISING A COVER MADE FROM AN ELECTROMAGNETIC-WAVE-ABSORBING MATERIAL

(71) Applicant: VALEO SYSTEMES D'ESSUYAGE, La Verriere (FR)

(72) Inventors: Alexandre FILLOUX, La Verriere (FR); Frederic GIRAUD, La Verriere (FR); Frederic BRETAGNOL, La Verriere (FR)

(73) Assignee: VALEO SYSTEMES D'ESSUYAGE, La Verriere (FR)

(21) Appl. No.: 18/719,886

(22) PCT Filed: Dec. 14, 2022
(86) PCT No.: PCT/EP2022/085789

§ 371 Date: Jun. 14, 2024

(30) Foreign Application Priority Data
Dec. 16, 2021 (FR) FR2113718

(51) Int. Cl. B08B 7/02; B08B 17/02; G02B 27/00

(52) U.S. Cl. CPC B08B 7/028; B08B 17/02; G02B 27/0006

(57) ABSTRACT

The present invention relates to a protection assembly for a cleaning assembly including a cleaning unit and an optical surface, with the cleaning unit having at least one wave transducer to be acoustically coupled to the optical surface. The protection assembly including a mechanical protection element configured to cover the wave transducer, such that the wave transducer is between the mechanical protection element and the optical surface. The protection assembly also includes a covering made of an electromagnetic wave absorbing material, the covering being capable of limiting electromagnetic radiation from the wave transducer outside the cleaning assembly.

### TECHNICAL FIELD

The present invention relates to a protection assembly of a cleaning assembly comprising a cleaning unit and an optical surface, the cleaning assembly being configured to clean a body in contact with the optical surface by means of ultrasound waves.

### BACKGROUND OF THE INVENTION

In various fields, it is necessary to overcome the effects associated with the build-up of a body, notably raindrops, ice or snow, on an optical surface.

It is known practice to cause drops of a liquid to rotate in order to remove them from a surface. However, such a technique is not suitable for surfaces with an area greater than a few square centimeters.

The use of an electrical field to control the hydrophobic property of a surface is also known, for example from KR 2018 0086173 A1. This technique, known by the acronym EWOD (which stands for Electro Wetting On Devices), consists in applying a potential difference between two electrodes so as to electrically polarize the surface and change the wetting properties thereof. By controlling the location of the polarization, the drop can then be moved. However, this technique can be implemented only with specific materials and requires the electrodes to be positioned particularly precisely over the entire surface the wetting properties of which are to be controlled.

It is also well-known practice to apply a mechanical force to the liquid, for example by means of a wiper on the windshield of a motor vehicle. However, a wiper limits the field of view accessible to the driver. It also spreads the greasy particles deposited on the surface of the windshield. In addition, the wiper blade rubbers need to be renewed regularly.

Moreover, autonomous motor vehicles include a large number of sensors to determine the distances and speeds of other vehicles on the road. Such sensors, for example lidars, are also subject to the weather and mud splashes and require frequent cleaning. However, a windshield wiper is not suitable for cleaning the small area of such a sensor. In addition, there is a need for such sensors to be compact, in order to be easily integrated within the vehicle. US 2016/0170203 A1 describes a device for cleaning a camera on a vehicle, using ultrasound waves.

However, such systems tend to cause interference, particularly when they are on board a vehicle which includes devices adapted to perform other vehicle functions (human-machine interface in the vehicle, driving assistance, lighting, etc.). To be specific, the generation of ultrasound waves is generally based on piezoelectric elements powered by currents which generate an electromagnetic field that can influence other devices located nearby.

There is therefore a need to efficiently remove a body, in particular a liquid, from an optical surface, without however disrupting the operation of neighboring devices.

### SUMMARY OF THE INVENTION

The present invention relates to a protection assembly of a cleaning assembly comprising a cleaning unit and an optical surface, the cleaning unit comprising at least one wave transducer intended to be acoustically coupled to the optical surface, the protection assembly comprising a mechanical protection element configured to cover the wave transducer, such that the wave transducer is between the mechanical protection element and the optical surface, the protection assembly comprising a covering made from an electromagnetic-wave-absorbing material, said covering being adapted to limit electromagnetic radiation from the wave transducer outside the cleaning assembly.

Thus, limiting the electromagnetic field generated by the transducer makes it possible to avoid negatively impacting the operation of other devices located near the cleaning assembly, and performing other functions or the same function.

According to one embodiment, the covering made from an electromagnetic-wave-absorbing material is applied at least partially to an inner face of the mechanical protection element facing the transducer or to an outer face of the mechanical protection element facing away from the transducer; and/or configured to be applied at least partially to a face of the optical surface between the optical surface and the transducer, or to a face of the optical surface facing away from the transducer.

Thus, the covering made from an electromagnetic-wave-absorbing material may be affixed to a part performing a function other than limiting the electromagnetic field of the transducer, which makes it possible to reduce the number of parts of the cleaning assembly, thus reducing the bulk and costs associated with the cleaning assembly.

In addition, the covering made from an electromagnetic-wave-absorbing material may be configured to be applied to a face of the optical surface on which a piezoelectric element of the transducer is placed, and wherein the covering made from an electromagnetic-wave-absorbing material may be adapted to ensure adhesion between the optical surface and the piezoelectric element.

Thus, the functions of limiting the electromagnetic radiation of the transducer and of attachment to the optical surface are shared.

In addition or as an alternative, the protection assembly may comprise a first electromagnetic-wave-absorbing covering arranged on the mechanical protection element, and a second electromagnetic-wave-absorbing covering configured to be arranged on the optical surface, the first metallic covering and the second covering being configured to form a Faraday cage.

Thus, the limitation of electromagnetic radiation from the transducer is maximized.

According to one embodiment, the mechanical protection element may comprise a plastic cap covered by the electromagnetic-wave-absorbing covering or comprises a cap made from an electromagnetic-wave-absorbing material constituting the covering.

Thus, the functions of limiting the electromagnetic radiation of the transducer and of mechanical protection for the transducer are shared.

According to one embodiment, the metallic covering may be a metallic mesh, wherein a mesh size is defined on the basis of parameters of the wave generated by the transducer.

Such an embodiment makes it possible to make the protection assembly more lightweight.

According to one embodiment, the protection assembly may further comprise an attachment element configured to be placed between the mechanical protection element and the optical surface, the attachment element comprising an adhesive foam.

Alternatively, the protection assembly may further comprise an attachment element configured to be placed between the mechanical protection element and the optical surface, the attachment element comprising an adhesive.

As another alternative, the protection assembly may further comprise an attachment element configured to be placed between the mechanical protection element and the optical surface, the attachment element comprising an adhesive film.

Such embodiments make it easier to attach the mechanical protection element to the optical surface while allowing sealing of the cleaning assembly.

A second aspect of the invention relates to a cleaning unit for cleaning an optical surface comprising at least one wave transducer intended to be acoustically coupled to the optical surface, the wave transducer comprising a piezoelectric element and electrodes of opposite polarity in contact with the piezoelectric element, and being configured to generate at least one ultrasound wave propagating in the optical surface; and a protection assembly according to the first aspect of the invention.

A third aspect of the invention relates to a cleaning assembly comprising:
an optical surface;
a cleaning unit for cleaning the optical surface according to the second aspect of the invention.

According to one embodiment of the invention, the optical surface may be one of the following:
a motor vehicle surface, for example selected from a windshield of a vehicle and a glazing of a rear-view mirror;
a surface of an optical device, for example selected from a camera lens, a lens of a pair of spectacles and a sensor, in particular a probe, for example a Pitot tube, or
a protection element of such an optical device.

### BRIEF DESCRIPTION OF DRAWINGS

Other features and advantages of the invention will also become apparent both from the following description and from several exemplary embodiments given by way of nonlimiting indication with reference to the attached schematic drawings, in which:

FIG. 1 shows a view in cross section of a cleaning assembly according to an embodiment of the invention;

FIG. 2 is a three-dimensional view of a transducer of a cleaning unit of a cleaning assembly according to an embodiment of the invention;

FIG. 3a depicts a sealing element of a protection assembly of a cleaning assembly according to a first embodiment of the invention;

FIG. 3b depicts a sealing element of a protection assembly of a cleaning assembly according to a second embodiment of the invention; and

FIG. 3c depicts a sealing element of a protection assembly of a cleaning assembly according to a third embodiment of the invention.

### DETAILED DESCRIPTION OF THE INVENTION

It should first of all be noted that, although the figures set out the invention in detail for its implementation, they may, of course, be used to better define the invention if necessary. It should also be noted that, in all of the figures, elements that are similar and/or perform the same function are indicated by the same numbering.

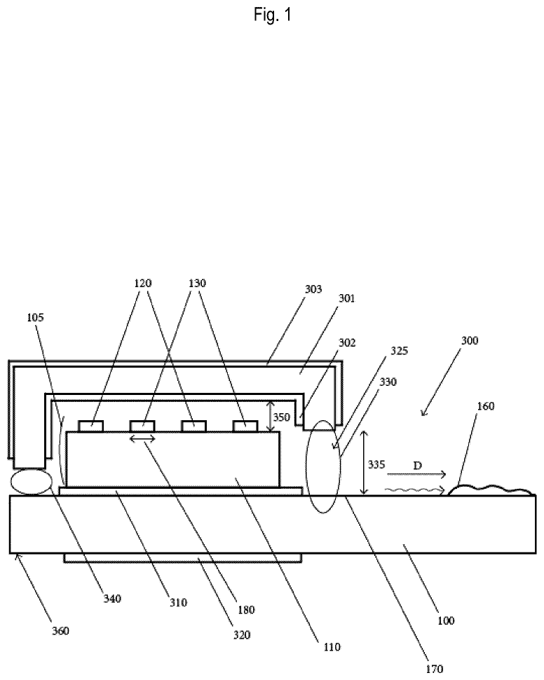

FIG. 1 depicts a cleaning assembly 300 according to an embodiment of the invention, comprising:
an optical surface 100;
a cleaning unit for cleaning the optical surface 100 comprising a transducer 105, the transducer comprising a substrate 110, a first electrode 120 and a second electrode 130. The electrodes 120 and 130 cover a first face of the substrate. In FIG. 1, the substrate is between the electrodes 120 and 130 and the optical surface 100. However, alternatively, the electrodes 120 and 130 may be between the substrate 110 and the optical surface 100.

The substrate 110 is a piezoelectric element, comprising for example 128° Y-cut lithium niobate or any other piezoelectric material. The substrate 110 may have the shape of a plate having a thickness less than or equal to 500 micrometers, μm.

The first and second electrodes 120 and 130 may be connected to a voltage generator, not shown in FIG. 1, which supplies them with power.

In the example shown, the optical surface 100 takes the form of a plate and has an upper face 170 in contact with the external environment. However, no restriction is imposed on the shape of the optical surface 100, which may in particular be curved. In the example shown, it is covered by a body 160, such as a film of water for example. No restriction is imposed on the body 160, which may be a solid body, such as an insect, a fatty body and/or a body of a liquid other than water. The body may have a part in the solid state and a part in the liquid state. For example, the body may be water and be formed of a frosty, icy or snowy portion and a liquid portion in contact with the frosty, icy or snowy portion, respectively.

The body in the liquid state may take the form of at least one drop or at least one film. “Film” means a thin film formed on the optical surface 100. The film may be continuous or discontinuous.

The body may be aqueous. In particular, it may be rainwater or dew water. The rainwater and/or dew water may in particular contain particles. Dew water forms a mist on the surface of a support. It results from the condensation on the support, under appropriate pressure and temperature conditions, of water in vapor form contained in the air. The body 160 may have been deposited by condensation before solidifying on the support.

The body in the solid state may be frost, ice or snow. The body in the liquid state may be a layer or at least one drop, for example mist.

The body 160 may be in contact with the upper face 170 of the optical surface 100 to which the transducer 105 is attached, or the face opposite the face 170 of the optical surface 100 to which the transducer is attached. The body 160 may be in contact with the face of the optical surface 100 to which the transducer 105 is attached and another body may be in contact with the opposite face.

To produce such a device, the first and second electrodes may be formed by an evaporation or spraying process and shaped by photolithography. They may be made of chromium, or aluminum, or a combination of an adhesion-promoting layer such as titanium with a conducting layer such as gold.

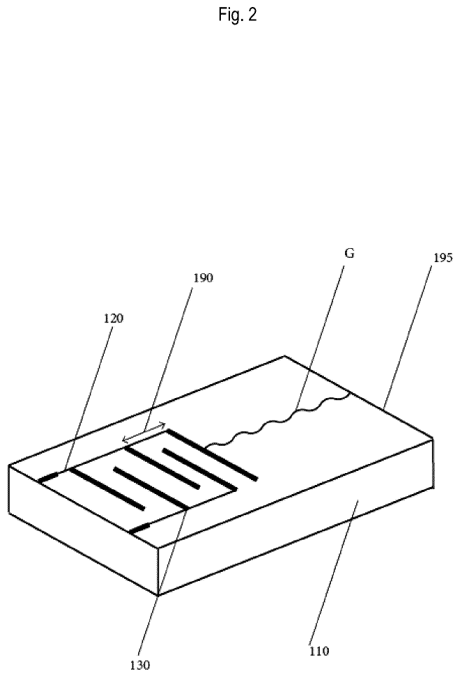

As shown in FIG. 2, the first and second electrodes 120 and 130 form combs. However, no restriction is imposed, according to the invention, on the shape of the first and second electrodes 120 and 130.

Each comb has a base and a row of fingers extending parallel to one another from the base. The first and second combs are interlaced. Each of the fingers of the first comb, respectively of the second comb, may have a width 180, indicated in FIG. 1, equal to the fundamental wavelength of the ultrasound wave divided by 4, and a spacing 190 between two consecutive fingers of a comb determines the resonant frequency of the transducer 105 that the person skilled in the art may easily determine. An alternating voltage is applied by the generator, such that the transducer generates a surface ultrasound wave.

For a liquid body 160, a transducer 105 synthesizing a surface wave of fundamental frequency between 0.1 MHz and 1000 MHz, preferably between 10 MHz and 100 MHz, for example equal to 40 MHz, is well suited to ensure the movement of the liquid body 160. In the alternative form whereby the film of water is in the form of ice or frost, the transducer is also well suited to causing the film of water to melt, through the application of the energy of the surface sound wave and the transfer of the heat that it generates.

The waves generated at the surface may have an amplitude of less than 500 nm, notably less than 100 nm, or even than 10 nm.

The transducer 105 may be bonded to the optical surface 100, notably by means of a polymer adhesive that also acoustically couples the transducer 105 to the optical surface 100. The adhesive may be UV-curable. It is, for example, an epoxy resin. The transducer 105 may be attached by molecular adhesion or by means of a thin metallic layer that provides the adhesion between the optical surface 100 and the substrate 110. The layer may be made from a metal or an alloy with a low melting point, i.e. having a melting point below 200° C., for example an indium alloy. As an alternative, the metallic layer may be made from a metal or an alloy having a melting point above 200° C., for example an aluminum and/or gold alloy. An example of bonding via molecular adhesion is described in “Glass-on-LiNbO3 heterostructure formed via a two-step plasma activated low-temperature direct bonding method”, J. Xu et al., Applied Surface Science 459 (2018) 621-629, doi: 10.1016/j.apsusc.2018.08.031. According to another alternative, the transducer 105 may be attached to the optical surface 100 by means of a process including a step of melting a portion of the substrate 110 and/or a portion of the optical surface 100, followed by a step consisting in compressing the substrate 110 and the optical surface 100 together, the respective molten portions of the optical surface 100 and of the substrate 110 being in contact with one another. According to another alternative, the transducer 105 may be attached to the optical surface 100 by means of a process including depositing bonding layers made of a low-melting alloy on a portion of the transducer 105 and on a portion of the optical surface 100, respectively, at least partially melting said bonding layers, then compressing the substrate 110 and the optical surface 100, the faces of the bonding layers that are the opposite faces from those facing the optical surface 100 and the substrate 110 being brought into contact with one another during the compression.

The bonding layers may be applied by cathodic sputtering, or using an evaporation technique used in the field of the application of thin layers.

The elements presented above do not ensure the protection of other devices located near the cleaning assembly 300, and providing other functions or the same function, against the electromagnetic field generated by the transducer 105.

The cleaning assembly 300 according to the invention further comprises a protection assembly comprising:
a mechanical protection element 301 for protecting the wave transducer 105, the transducer 105 being between the mechanical protection element 301 and the optical surface 100,
at least one covering 302, 303, 310 or 320 made from an electromagnetic-wave-absorbing material, such as a metallic material, adapted to limit electromagnetic radiation from the wave transducer outside the cleaning assembly.

The invention applies to any material that has the property of absorbing electromagnetic waves. For example, as an alternative to a metallic material, the covering may comprise a layer of textile printed with at least one conducting ink in at least one pattern comprising printed zones and non-printed zones in an arrangement suited to a corresponding range of absorption frequencies. In what follows, it is considered, solely by way of illustration, that the material that absorbs electromagnetic waves is a metallic material.

The covering of the protection assembly may comprise:
an inner metallic layer 302 of the mechanical protection element 301, oriented toward the transducer 105, and/or an outer metallic layer 303 of the mechanical protection element, on a face of the mechanical protection element 301 facing away from the transducer 105. The mechanical protection element 301 may comprise a body made from a nonmetallic material, for example a plastic, as well as one and/or the other of the metallic coverings 301 and 302. In an alternative, the mechanical protection element 301 may itself be made of metal and thus constitute a metallic covering element per se, in which case neither of the metallic coverings 301 and 302 is added; and/or
a metallic layer 320 on a face 360 of the optical surface 100 facing away from the transducer 105, or a metallic layer 310 serving to join the substrate 110 to the optical surface 100, as described hereinabove. Thus, when a metallic layer 110 is provided to join the substrate 110 to the optical surface 100, there is no need to provide the metallic layer 320 as well. However, when the join between the substrate 110 and the optical surface 100 is nonmetallic, it is easier to apply a metallic layer 320 to the face 360.

Advantageously, the metallic joining layer 310 may have a surface area greater than that of the substrate 110, as depicted in FIG. 1. The electromagnetic radiation directed toward the face 360 of the optical surface 100 is thus limited.

Note that the metallic covering or the metallic coverings may be a continuous metallic layer, or a discontinuous metallic layer, such as a mesh, the mesh size being determined from parameters of the ultrasound wave generated by the transducer 105, such as notably the frequency or wavelength of the ultrasound wave. Such determination is well known and not described further.

No restriction is imposed on the mechanical protection element 301, which is preferably rigid.

No restriction is imposed on the shape of the mechanical protection element 301. In FIG. 1, the mechanical protection element 301 takes the form of a rectangular parallelepiped or of a cube, depending on its dimensions in the plane of the optical surface 100. The contact surface for contact between the mechanical protection element 301 and the optical surface 100 is therefore a rectangle or square. However, the mechanical protection element 301 may, as an alternative, be parabolic, and its contact surface for contact with the optical surface 100 is therefore a circle or an oval.

The mechanical protection element 301 may further comprise an opening 325 able to allow the ultrasound wave to propagate over the optical surface 100 out of the protection assembly.

Advantageously, the protection assembly of the cleaning assembly 300 comprises a metallic covering 302 or 303 associated with the mechanical protection element 301 and a metallic covering element 310 or 320 associated with the optical surface 100, in such a way as to constitute a Faraday cage, with the exception of the opening 325. The benefit of an opening 325 of small size will therefore be all the better appreciated, so as to limit electromagnetic losses to outside the cleaning assembly 300. Thus, the cleaning assembly 300 may be positioned near to other devices, having other functions, without disrupting the operation thereof.

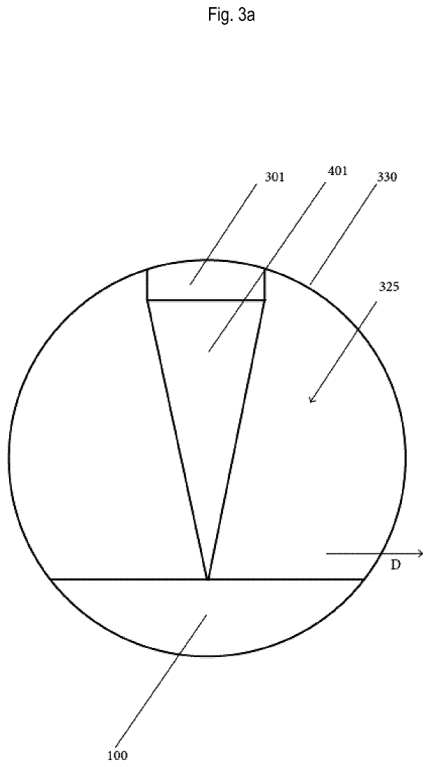

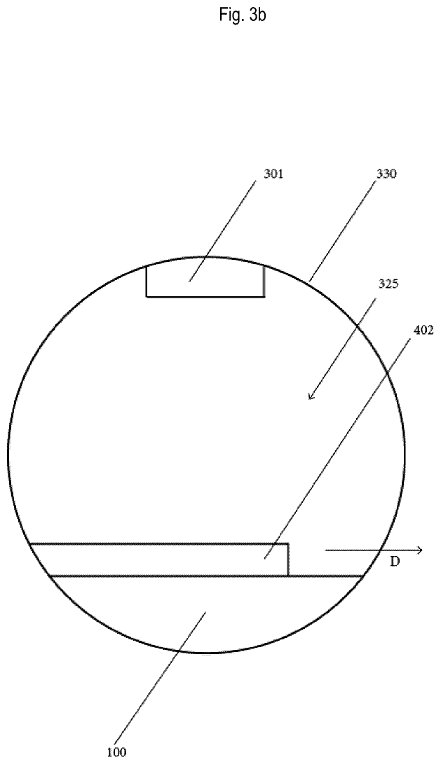

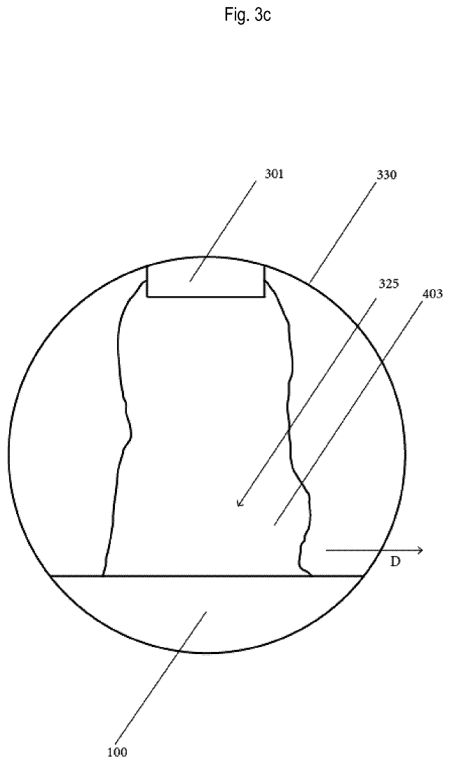

The protection assembly may further comprise a sealing element in the vicinity of the opening 325, not depicted in FIG. 1 but described with reference to FIGS. 3a to 3c, and able to limit the passage of liquid through the opening 325.

Furthermore, no restriction is imposed on the shape of the opening 325. It may, for example, be a rectangular slot extending over all or part of one side of the rectangle or of the square that constitutes the contact surface for contact between the mechanical protection element 301 and the optical surface 100. This is notably on the side oriented in the direction D of propagation of the ultrasound wave generated by the transducer 105, in such a way as to allow the ultrasound wave to propagate out of the protection assembly in the direction D of propagation. When the contact surface for contact between the optical surface 100 and the mechanical protection element 301 is a circle or an oval, the opening 325 may extend over a portion of the circle or of the oval, notably a portion lying on the path of the ultrasound wave propagating in the direction D of propagation.

The opening 325 notably defines a space 335 between the mechanical protection element 301 and the optical surface 100, the space 335 being of a dimension greater than half the amplitude of the ultrasound wave generated by the transducer 105, in such a way as to allow the wave to pass.

However, the size of the opening 325 needs to be limited so as to make it easier to maintain the fluidtightness of the inside of the mechanical protection element 301; for example, the size needs to be less than 100 micrometers.

Thus, the opening 325 advantageously makes it possible to maximize the mechanical protection afforded to the transducer 105 while at the same time allowing ultrasound waves to pass in the direction D of propagation.

For example, the distance 335 may be greater than 10 nanometers, for example equal to 20 or 30 nanometers. As an alternative, the distance 335 may be greater than 10 micrometers, for example equal to 20 or 30 micrometers.

As shown in FIG. 1, a non-zero distance 350 may be provided between the substrate and the protection element 301, in such a way as not to disrupt the ultrasound wave generated as it travels over the upper surface of the substrate 110 before reaching the optical surface 100. For this purpose, the distance 350 may be greater than 10 nanometers, or even greater than 100 nm, or even greater than 500 nm.

When the electrodes 120 and 130 are between the substrate 110 and the optical surface 100, the distance 350 may be zero as long as the thickness of the substrate 110 is greater than half the amplitude of the ultrasound waves generated. The bulk associated with the cleaning assembly 300 is thus reduced.

FIG. 1 also depicts the vicinity 330 of the opening 325, defining what is situated close to the opening 325. The size of this vicinity 330 may vary, and may notably be dependent on the size of the opening and on the dimensions and shape of the mechanical protection element. For example, the vicinity 330 may consist of any point in space that is situated less than a predetermined distance away from the opening 325. The predetermined distance may be a fraction of a dimension of the mechanical protection element 301, such as one fifth, one tenth or one twentieth of a horizontal dimension of the mechanical protection element 301, that is to say a dimension parallel to the plane of the optical surface 100.

The sealing element is advantageously situated in the vicinity 330 of the opening 325, in such a way as to improve the fluidtightness between the inside and the outside of the protection assembly of the cleaning assembly 300.

The mechanical protection element 301 is attached to the optical surface 100 via an attachment element 340 for attaching the protection assembly, which may be an adhesive, an adhesive film or an adhesive foam. The attachment element may notably be spread at the contact surface for contact between the mechanical protection element 301 and the optical surface 100, with the exception of the contact surface corresponding to the opening 325, except in the embodiment of FIG. 3c, which will be described later. For example, the attachment element 340 may be spread over three sides of the rectangle or square that forms the contact surface, with the exception of the side oriented in the direction D of propagation of the ultrasound waves generated from the substrate 110.

FIG. 3a shows a sealing element according to a first embodiment, placed in the vicinity 330 of the opening 325.

The sealing element is a rubber component 401 arranged in the opening 325 in such a way as to obstruct same, connected to the mechanical protection element 301 and in contact with the optical surface 100. The contact with the optical surface 100 may be linear contact in such a way as to make it easier for the component 401 to deform in order to allow the ultrasound wave to pass. The sealing element thus makes it possible to improve the fluidtightness of the cleaning assembly 300, so as to protect the transducer 105, while at the same time allowing the ultrasound waves generated to pass in the direction D to the outside of the protection assembly 301 of the cleaning assembly 300.

The component 401 may have a triangular cross section as depicted in FIG. 3a, to make it easier to attach to the mechanical protection element 301 while at the same time ensuring linear contact with the optical surface 100. The component 401 may have a maximum thickness, in the direction D, that is less than 2 mm, notably less than 1 mm or even less than 500 μm.

FIG. 3b shows a sealing element 402 according to a second embodiment, placed in the vicinity 330 of the opening 325.

The sealing element 402 according to the second embodiment is a hydrophobic or superhydrophobic coating 402 of the optical surface 100 arranged in the vicinity of the opening 325 of the mechanical protection element 301. It is preferentially arranged at least partially on the optical surface in the immediate vicinity of the opening and at the very least on the outside of the mechanical protection element 301 in the direction D of propagation. As a preference, the hydrophobic or superhydrophobic coating 402 is arranged on the optical surface facing the opening 325.

As an alternative or in addition, the hydrophobic or superhydrophobic coating 402 is arranged on a wall of the mechanical protection element 301 that forms the opening 325.

The hydrophobic or superhydrophobic coating 402 makes it possible to improve the sealing of the cleaning assembly so as to protect the transducer 105 without impact on the passage of the generated ultrasound waves toward the outside of the mechanical protection element 301 in the direction D of propagation.

FIG. 3c shows a sealing element according to a third embodiment, placed in the vicinity 330 of the opening 325. According to the third embodiment, the sealing element performs a function of attaching the mechanical protection element 301 to the optical surface. The sealing element may notably be an adhesive or an adhesive foam 403, the properties of which allow the ultrasound wave to pass through it. In particular, the hardness associated with the sealing element is greater than a predetermined threshold hardness, so as to reduce the absorption of the ultrasound wave passing through the sealing element. The adhesive or adhesive foam 403 may have a maximum width, in the direction D, that is less than 2 mm, notably less than 1 mm or even less than 500 μm. The adhesive or adhesive foam 403 may have a maximum thickness, in the direction perpendicular to the direction D of propagation, that is less than 3 mm, notably less than 1 mm or even less than 500 μm.

The sealing element may thus form the one same element with the attachment element 340 set out hereinabove. Thus, the mechanical protection element 301 is attached in the one same step by spreading the foam or the adhesive over the entire contact surface for contact between the mechanical protection element 301 and the optical surface 100.

The sealing elements set out hereinabove may also be combined. In particular, the hydrophobic or superhydrophobic coating 402 may be used in combination with the rubber component 401 or with the adhesive foam or adhesive 403.

Note that the cleaning assembly 300 according to the invention may comprise several transducers 105, for example oriented in different directions. Each transducer 105 may comprise a dedicated mechanical protection element 301, and a sealing element as described hereinabove.

As an alternative, the mechanical protection element 301 may be shared between several transducers 105. The mechanical protection element may then comprise:
an opening 325 shared between the various transducers 105 with a sealing element in common;
an opening 325 for each transducer 105, with a sealing element arranged in the vicinity of each opening 325.

Of course, the invention is not limited to the examples that have just been described, and numerous modifications may be made to these examples without departing from the scope of the invention

What is claimed is:

1. A protection assembly of a cleaning assembly including a cleaning unit and an optical surface, the cleaning unit including at least one wave transducer (105) intended to be acoustically coupled to the optical surface,
the protection assembly comprising a mechanical protection element configured to cover the wave transducer, such that the wave transducer is between the mechanical protection element and the optical surface, and
a covering made from an electromagnetic-wave-absorbing material, the covering being adapted to limit electromagnetic radiation from the wave transducer outside the cleaning assembly.

2. The protection assembly as claimed in claim 1, wherein the covering is applied at least partially to an inner face of the mechanical protection element facing the transducer or to an outer face of the mechanical protection element facing away from the transducer; and/or configured to be applied at least partially to a face of the optical surface between the optical surface and the transducer, or to a face of the optical surface facing away from the transducer.

3. The protection assembly as claimed in claim 2, wherein the covering is configured to be applied to the face of the optical surface on which a piezoelectric element of the transducer is intended to be placed, and wherein the covering is adapted to ensure adhesion between the optical surface and the piezoelectric element.

4. The protection assembly as claimed in claim 1, further comprising a second electromagnetic-wave-absorbing covering configured to be arranged on the optical surface, with the covering and the second electromagnetic-wave-absorbing covering being configured to form a Faraday cage.

5. The protection assembly as claimed in claim 1, wherein the mechanical protection element includes a plastic cap covered by the covering or comprises a cap made from an electromagnetic-wave-absorbing material constituting the covering.

6. The protection assembly as claimed in claim 1, wherein the covering is a metallic mesh, wherein a mesh size is defined on the basis of parameters of the wave generated by the transducer.

7. The protection assembly as claimed in claim 1, further comprising an attachment element configured to be placed between the mechanical protection element and the optical surface, the attachment element comprising an adhesive foam.

8. The protection assembly as claimed in claim 1, further comprising an attachment element configured to be placed between the mechanical protection element and the optical surface, the attachment element comprising an adhesive.

9. A cleaning unit for cleaning an optical surface comprising
at least one wave transducer intended to be acoustically coupled to the optical surface, the wave transducer including a piezoelectric element and electrodes of opposite polarity in contact with the piezoelectric element, and being configured to generate at least one ultrasound wave propagating in the optical surface; and
a protection assembly including a mechanical protection element configured to cover the at least one wave transducer, such that the at least one wave transducer is between the mechanical protection element and the optical surface, and a covering made from an electromagnetic-wave-absorbing material, the covering being adapted to limit electromagnetic radiation from the wave transducer outside the cleaning assembly.

10. A cleaning assembly comprising:
an optical surface;
a cleaning unit for cleaning the optical surface, with the clean unit including at least one wave transducer intended to be acoustically coupled to the optical surface, the wave transducer including a piezoelectric element and electrodes of opposite polarity in contact with the piezoelectric element, and being configured to generate at least one ultrasound wave propagating in the optical surface, and a protection assembly including a mechanical protection element configured to cover the at least one wave transducer, such that the at least one wave transducer is between the mechanical protection element and the optical surface, and a covering made from an electromagnetic-wave-absorbing material, the covering being adapted to limit electromagnetic radiation from the wave transducer outside the cleaning assembly.
